(19) United States
(12) Patent Application Publication
(10) Pub. No.: US 2017/0260787 A1
(43) Pub. Date: Sep. 14, 2017

(54) SLIDE DOOR APPARATUS FOR VEHICLE

(71) Applicant: AISIN SEIKI KABUSHIKI KAISHA, Kariya-shi (JP)

(72) Inventors: Masayuki UCHITSUNEMI, Chiryu-shi (JP); Tadao YUKI, Nishio-shi (JP); Yasuaki TANINO, Toyoake-shi (JP)

(73) Assignee: AISIN SEIKI KABUSHIKI KAISHA, Kariya-shi (JP)

(21) Appl. No.: 15/446,619

(22) Filed: Mar. 1, 2017

(30) Foreign Application Priority Data
Mar. 10, 2016 (JP) 2016-046823

(51) Int. Cl. E05D 15/06; E05D 15/56

(52) U.S. Cl. CPC E05D 15/0613; E05D 15/56

(57) ABSTRACT

A slide door apparatus for a vehicle includes: a guide rail extending in a front and rear direction along a peripheral edge of a door opening part formed on a lateral side of a vehicle body; and a guide roller unit supporting the slide door on the lateral side, in which the guide rail includes first and second guide roller engagement units extending in the front and rear direction in parallel with each other in a width direction, and the first guide roller engagement unit includes a first curved portion, and the second guide roller engagement unit is disposed inside in the width direction compared to the first guide roller engagement unit such that a distance of the second guide roller engagement unit from the first guide roller engagement unit in the width direction is decreased at an end portion side in the closing direction of the slide door.

### CROSS REFERENCE TO RELATED APPLICATIONS

This application is based on and claims priority under 35 U.S.C. §119 to Japanese Patent Application 2016-046823, filed on Mar. 10, 2016, the entire contents of which are incorporated herein by reference.

### TECHNICAL FIELD

This disclosure relates to a slide door apparatus for a vehicle.

### BACKGROUND DISCUSSION

In general, a slide door apparatus for a vehicle has plural guide rails which extend in a front and rear direction of the vehicle, and plural guide roller units which are connected to the guide rails, respectively, so as to be movable relative to the guide rails in the extending direction of the guide rails. Further, a slide door is supported on a vehicle body via the guide rails and the guide roller units to be capable of opening and closing a door opening part of the vehicle, which is formed on a lateral side of the vehicle body, based on the forward and rearward movements of the slide door in the extending direction of the guide rails.

Typically, a guide rail of such a slide door apparatus has a curved shape that is curved in the vehicle width direction at one end in the extending direction of the guide rails. That is, during the opening/closing operation of the slide door, the guide roller unit connected to the guide rail passes through the curved portion, and as a result, the slide door, which is supported on the vehicle body via the guide rails and the guide roller units, is displaced in the vehicle width direction. Accordingly, the slide door, which is opened and closed in the front and rear directions of the vehicle, may be disposed at a completely closed position in a state in which the outer surface of the slide door is flush with the lateral surface of the vehicle body without causing the slider to interfere with the vehicle body.

However, because the guide rails are disposed along the peripheral edge of the door opening part, the curved portions, which extend inward in the vehicle width direction toward the closing direction of the slide door, and the accommodating spaces of the guide roller units, which are connected to the guide rails in the completely closed position of the slide door, occupy an interior space of the vehicle.

In light of this, for example, in a slide door apparatus disclosed in JP 2008-285964A (Reference 1), first and second rails, which are parallel to each other in the vehicle width direction, are installed at a lower rail disposed at a lower edge of the door opening part. In addition, a lower guide roller unit connected to the lower rail is provided with a support arm, which is rotatably connected to the slide door, and first and second roller support portions, which are rotatably connected to the support arm. In addition, the first roller support portion is provided with a guide roller that is engaged with the first rail, and the second roller support portion is provided with a guide roller that is engaged with the second rail. Further, the lower rail is formed to have a configuration in which the second rail disposed inside in the vehicle width direction is curved inwardly in the vehicle width direction to be spaced apart from the first rail at an end portion in the closing direction of the slide door.

By adopting the aforementioned configuration, the support arm connected to the slide door may be more greatly rotated. Further, at this time, a relative position between the first and second roller support portions guided by the first and second rails is changed such that the guide roller unit accommodating space may be suppressed smaller.

Even in the related art, the curved end portion of the second rail, which extends inward in the vehicle width direction to be spaced apart from the first rail, occupies the interior space of the vehicle. Further, in practice, it is impossible to sufficiently inhibit the occupation of the interior space of the vehicle by the guide roller unit accommodating space even if the guide roller unit accommodating space may be suppressed smaller. Thus, there is still room for further improvement in this respect.

### SUMMARY

Thus, a need exists for a slide door apparatus for a vehicle which is not suspectable to the drawback mentioned above.

A slide door apparatus for a vehicle according to an aspect of this disclosure includes: a guide rail extending in a front and rear direction of the vehicle along a peripheral edge of a door opening part formed at a lateral side of a vehicle body, and a guide roller unit that supports the slide door on the lateral side of the vehicle body in a state in which the guide roller unit is connected to the guide rail. The guide rail includes first and second guide roller engagement units extending in the front and rear direction of the vehicle in parallel with each other in a width direction of the vehicle, the guide roller unit includes a first rotating arm rotatably connected to the slide door, and the first rotating arm is provided with a first guide roller engaged with the first guide roller engagement unit and a second guide roller engaged with the second guide roller engagement unit. The first guide roller engagement unit includes a first curved portion, which is curved inward in the width direction of the vehicle in a closing direction of the slide door, at an end portion in the closing direction of the slide door, and the second guide roller engagement unit is disposed further inward in the width direction of the vehicle than the first guide roller engagement unit, such that a separation distance in the width direction of the vehicle from the first guide roller engagement unit is decreased at the end portion in the closing direction of the slide door.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view illustrating a schematic configuration of a slide door apparatus;

FIG. 2 is a front view of an upper roller unit connected to an upper rail;

FIG. 3 is a front view of a center roller unit connected to a center rail;

FIG. 4 is a top plan view of the center rail and the center roller unit connected to the center rail;

FIG. 5 is an operation explanatory view of the center roller unit which is moved in front and rear directions of a vehicle by being guided by the center rail;

FIG. 6 is a front view of a lower roller unit connected to a lower rail;

FIG. 7 is a top plan view of the lower rail and the lower roller unit connected to the lower rail (a completely opened position of the slide door);

FIG. 8 is a perspective view of the lower roller unit (a deployed state);

FIG. 9 is a perspective view of the lower roller unit (a transition state);

FIG. 10 is a perspective view of the lower roller unit (a folded state);

FIG. 11 is a top plan view of the lower rail and the lower roller unit in the vicinity of a completely closed position of the slide door; and

FIG. 12 is a top plan view of the lower rail and the lower roller unit in the completely closed position of the slide door.

### DETAILED DESCRIPTION

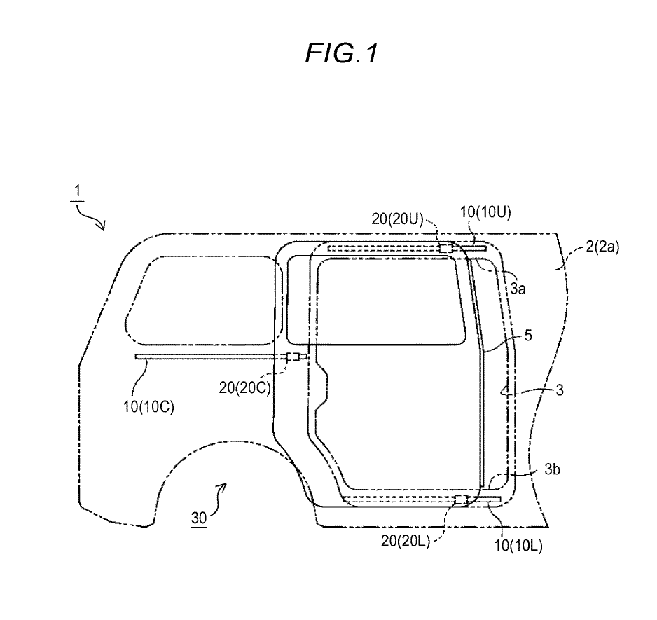

Hereinafter, an embodiment of a slide door apparatus for a vehicle will be described with reference to the drawings. As illustrated in FIG. 1, a vehicle 1 is provided with a slide door 5 that opens and closes a door opening part 3 provided at a lateral side 2a of a vehicle body 2. In addition, in the vehicle 1 of the present embodiment, the slide door 5 is installed as a rear door of the vehicle 1. Further, the slide door 5 is configured to be opened by being moved toward the rear side of the vehicle (the left side in FIG. 1), and closed by being moved toward the front side of the vehicle.

In detail, the vehicle 1 of the present embodiment is provided with a slide door apparatus 30 that includes plural (three) guide rails 10 extending in the front and rear direction of the vehicle (the left and right direction in FIG. 1), and plural guide roller units 20 (20U, 20C, and 20L) connected to the guide rails 10 (10U, 10C, and 10L), respectively. Further, the slide door 5 of the present embodiment is supported at the lateral side 2a of the vehicle body 2 via the respective guide rails 10 and the respective guide roller units 20 such that it is possible for the slide door 5 to open and close the door opening part 3 formed on the lateral side 2a of the vehicle body 2 by being moved in the front and rear direction of the vehicle (the left and right direction in FIG. 1).

Specifically, the slide door apparatus 30 of the present embodiment includes an upper rail 10U installed at the upper edge portion 3a of the door opening part 3, a center rail 10C installed at the rear side of the door opening 3, and a lower rail 10L installed at a lower edge portion 3b of the door opening part 3. In addition, the slide door apparatus 30 includes an upper roller unit (upper guide roller unit) 20U connected to the upper rail 10U in a state of being supported at a front upper end portion of the slide door 5. In addition, the slide door apparatus 30 includes a center roller unit (center guide roller unit) 20C connected to the center rail 10C in a state of being supported at a rear intermediate portion of the slide door 5. Further, the slide door apparatus 30 includes a lower roller unit (lower guide roller unit) 20L connected to the lower rail 10L in a state of being supported at a front lower end portion of the slide door 5.

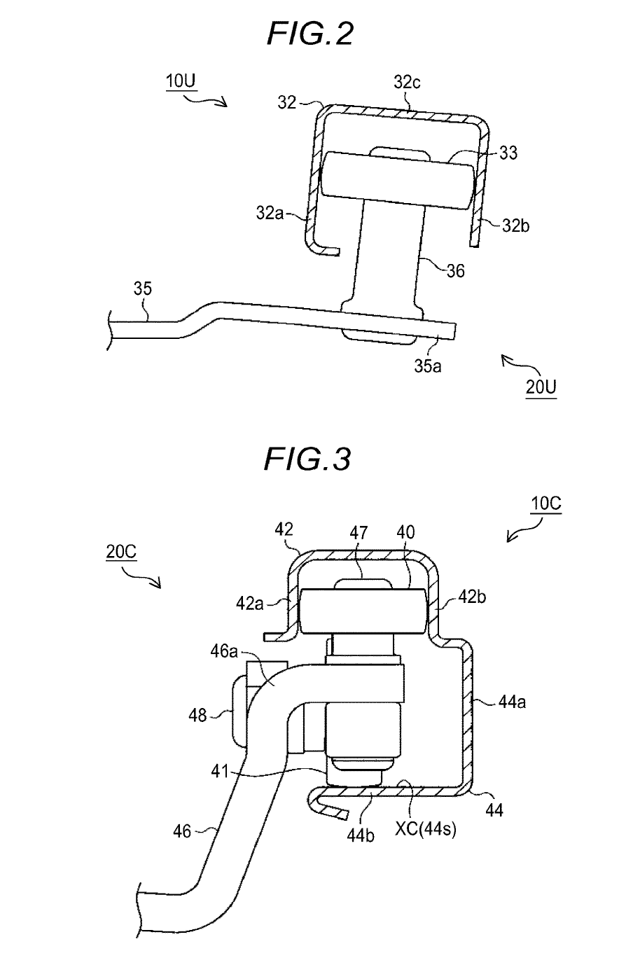

In more detail, as illustrated in FIG. 2, the upper rail 10U of the present embodiment includes a guide roller engagement unit 32 of a U-shaped cross section, which is opened at a lower side (the lower side in FIG. 2) and has a pair of sidewalls 32a and 32b which face each other in a width direction of the vehicle (the left and right direction in FIG. 2), and an upper wall 32c which interconnects upper end portions of the two sidewalls 32a and 32b. Further, the upper roller unit 20U is provided with a guide roller 33 disposed in the guide roller engagement unit 32.

Specifically, the upper roller unit 20U of the present embodiment has a support arm 35 fixed to an inner surface 5s of the slide door 5 at the front upper end portion (see FIG. 1) of the slide door 5. In addition, a support shaft 36, which extends in an up and down direction, is provided in a tip end portion 35a of the support arm 35. Further, the guide roller 33 is configured to be disposed between the two sidewalls 32a and 32b that constitute the guide roller engagement unit 32 of the upper rail 10U in a state in which the guide roller 33 is rotatable by being pivotally supported at a tip end of the support shaft 36.

That is, as the guide roller 33 is abutted on any one of the sidewalls 32a and 32b, the guide roller engagement unit 32 of the upper rail 10U restricts a relative movement of the guide roller 33 in the width direction (the left and right direction in FIG. 2). In addition, as any one of the sidewalls 32a and 32b, which is abutted on the guide roller 33, becomes a sliding surface, the guide roller engagement unit 32 permits the relative movement of the guide roller 33 in the extension direction thereof (a direction orthogonal to the paper surface in FIG. 2). Thus, the upper rail 10U of the present embodiment is configured to guide the upper roller unit 20U connected to the upper rail 10U, along the extension direction.

As illustrated in FIG. 3, like the guide roller 33 of the upper roller unit 20U, the center roller unit 20C of the present embodiment is provided with guide rollers 40 engaged with the center rail 10C so as to guide the center roller unit 20C in the extension direction of the center rail 10C. In addition, the center roller unit 20C is provided with a load roller 41 to support the load of the slide door 5. Further, the center rail 10C of the present embodiment is configured to include a guide roller engagement unit 42 engaged with the guide rollers 40, and a load roller support unit 44 having a sliding surface XC for the load roller 41.

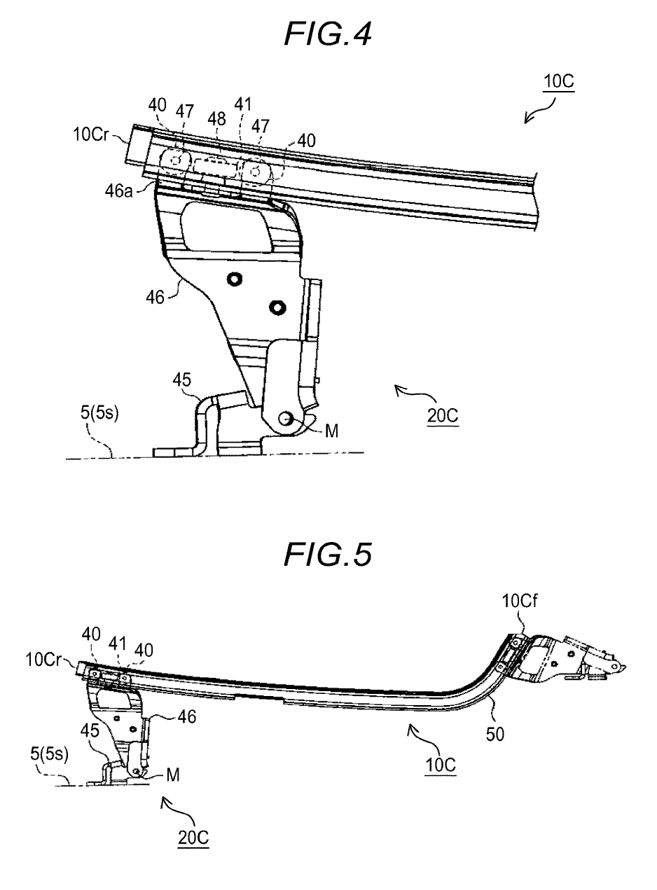

In more detail, as illustrated in FIG. 4, the center roller unit 20C of the present embodiment is provided with a support bracket 45 fixed to the inner surface 5s of the slide door 5 at the rear intermediate portion (see FIG. 1) of the slide door 5, and a rotating arm 46 rotatably connected to the support bracket 45 via a rotating shaft M extending at a base end portion in the up and down direction. Further, the guide rollers 40 and the load roller 41 are provided at the tip end portion 46a of the rotating arm 46, which extends from the slide door 5 side toward the vehicle body 2 side.

Specifically, as illustrated in FIGS. 3 and 4, the rotating arm 46 is provided with two support shafts 47, which extend in the up and down direction at mutually spaced positions, at the tip end portion 46a thereof. Further, the center roller unit 20C of the present embodiment is provided with a pair of guide rollers 40, which are pivotally supported on the support shafts 47, respectively.

The rotating arm 46 is provided with a support shaft 48, which extends in a direction (the left and right direction in FIG. 3) that intersects the respective support shafts 47 of the guide rollers 40, which extend in the up and down direction, at the tip end portion 46a thereof. Specifically, the support shaft 48 is provided at an intermediate position between the respective support shafts 47 and at the lower side of the respective support shafts 47 of the guide rollers 40. Further, the load roller 41 is rotatably and pivotally supported at the tip end of the support shaft 48.

Meanwhile, as illustrated in FIG. 3, like the upper rail 10U, the guide roller engagement unit 42 of the center rail 10C of the present embodiment has a substantially U-shaped cross section, which is opened at a lower side (a lower side in FIG. 3). In addition, the load roller support unit 44 is provided at a lower side of the guide roller engagement unit 42. Further, the center rail 10C of the present embodiment is configured such that the guide roller engagement unit 42 and the load roller support unit 44 are integrally formed by roll forming.

That is, the center roller unit 20C of the present embodiment is connected to the center rail 10C in a state in which the respective guide rollers 40 are disposed between two sidewalls 42a and 42b that constitute the guide roller engagement unit 42. Further, the center rail 10C of the present embodiment is thus configured to guide the center roller unit 20C in the extension direction (a direction orthogonal to the paper surface in FIG. 3) as the sidewalls 42a and 42b become sliding surfaces for the respective guide rollers 40 that come into contact with the sidewalls 42a and 42b.

The load roller support unit 44 of the center roller unit 20C of the present embodiment has a sidewall 44a which is provided in such a way that one sidewall 42b, which constitutes the guide roller engagement unit 42, extends downward, and a lower wall 44b which is provided in such a way that a lower end of the sidewall 44a is bent outward in the width direction of the vehicle (toward a left side in FIG. 3). Specifically, in the present embodiment, the lower wall 44b of the load roller support unit 44 is provided to extend outward in the width direction of the vehicle to a position which is a lower side of the respective support shafts 47 of the guide rollers 40. Further, the center rail 10C of the present embodiment is configured such that as the load roller 41 of the center roller unit 20C comes into contact with the lower wall 44b from an upper side, an upper surface 44s of the lower wall 44b serves as the sliding surface XC for the load roller 41.

Here, as illustrated in FIG. 5, the center rail 10C of the slide door apparatus 30 of the present embodiment has a curved portion 50 which is curved inward in the width direction of the vehicle (upward in FIG. 5) toward a front side of the vehicle, and as a result, in the closing direction of the slide door 5 (toward a right side in FIG. 5), at a front end portion 10Cf, that is, at an end portion in the closing direction of the slide door 5. In addition, the upper rail 10U and the lower rail 10L also have curved portions, respectively, which extend inward in the width direction of the vehicle in the closing direction of the slide door 5, at a front end portion positioned in the closing direction of the slide door 5. Further, the slide door apparatus 30 of the present embodiment is configured such that the slide door 5 is opened and closed in the front and rear direction of the vehicle while being displaced in the width direction of the vehicle based on the predetermined curved shapes of the respective guide rails 10 (10U, 10C, and 10L).

For example, as the center roller unit 20C of the present embodiment moves to the curved portion 50 provided at the front end portion 10Cf of the center rail 10C, the rotating arm 46, which supports the guide rollers 40 and the load roller 41, rotates about the rotating shaft M counterclockwise in FIG. 5 relative to the support bracket 45 fixed to the slide door 5. Further, the slide door apparatus 30 of the present embodiment is thus configured such that as the slide door 5, which is supported by the center rail 10C through the center roller unit 20C, is displaced inward in the width direction of the vehicle, the outer surface of the slide door 5 is disposed to be substantially flush with the lateral side 2a of the vehicle body 2 in the completely closed position of the slide door 5.

The center roller unit 20C of the present embodiment rotates clockwise in FIG. 5 relative to the support bracket 45 as the center roller unit 20C moves from the curved portion 50 provided at the front end portion 10Cf to a rear end portion 10Cr of the center rail 10C, that is, in the direction (leftward in FIG. 5) in which the slide door 5 is opened. Further, the slide door apparatus 30 of the present embodiment is thus configured such that the slide door 5, which is opened, does not interfere with the lateral side 2a of the vehicle body 2.

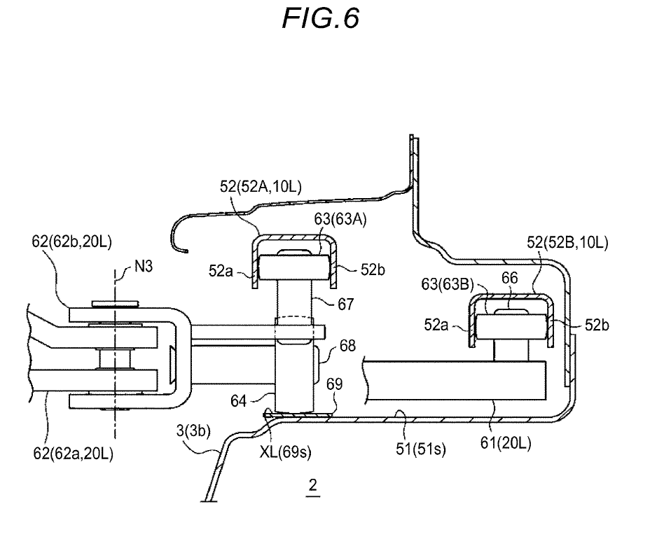

As illustrated in FIG. 6, in the vehicle 1 of the present embodiment, a concave portion 51, which is opened outward in the width direction of the vehicle (leftward in FIG. 6), is formed at a position which is the lower edge portion 3b of the door opening part 3 at the lateral side 2a of the vehicle body 2. Further, the lower rail 10L of the present embodiment is provided in the concave portion 51.

In detail, the lower rail 10L of the present embodiment has first and second guide roller engagement units 52A and 52B which are parallel to each other in the width direction of the vehicle and extend in the front and rear direction of the vehicle (the direction orthogonal to the paper surface in FIG. 6). Specifically, like the respective guide roller engagement units 32 and 42 of the upper rail 10U and the center rail 10C, each of the guide roller engagement units 52 (52A and 52B) has an external shape of a substantially U-shaped cross section which is opened at a lower side of the vehicle 1 (a lower side in FIG. 6). In addition, each guide roller engagement unit 52 is disposed within the concave portion 51 formed in the lower edge portion 3b of the door opening part 3 at a position where a gap is formed between the guide roller engagement unit 52 and the bottom surface 51s of the concave portion 51. Further, the lower roller unit 20L is provided with a first guide roller 63A engaged with the first guide roller engagement unit 52A and a second guide roller 63B engaged with the second guide roller engagement unit 52B.

That is, the lower roller unit 20L of the present embodiment is connected to the lower rail 10L in a state in which each of the guide rollers 63 (63A and 63B) is disposed between two sidewalls 52a and 52b that constitute each of the guide roller engagement units 52 (52A and 52B), respectively. Thus, the lower rail 10L of the present embodiment is configured to guide the lower roller unit 20L in the extension direction of the lower rail 10L (a direction orthogonal to the paper surface in FIG. 6) as the sidewalls 52a and 52b become sliding surfaces for the respective guide rollers 63 that are abutted on the sidewalls 52a and 52b, respectively.

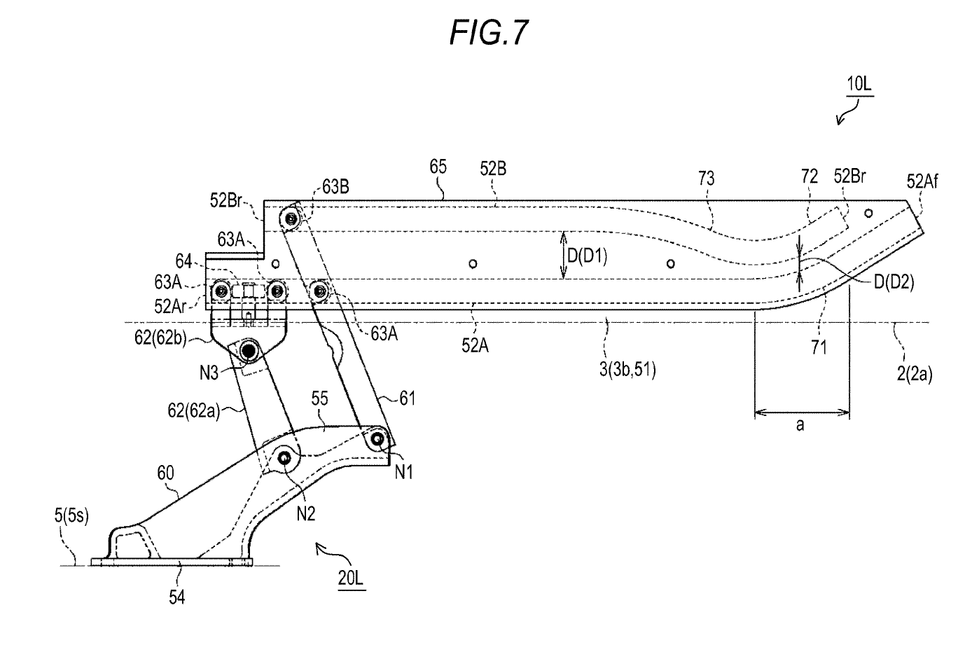

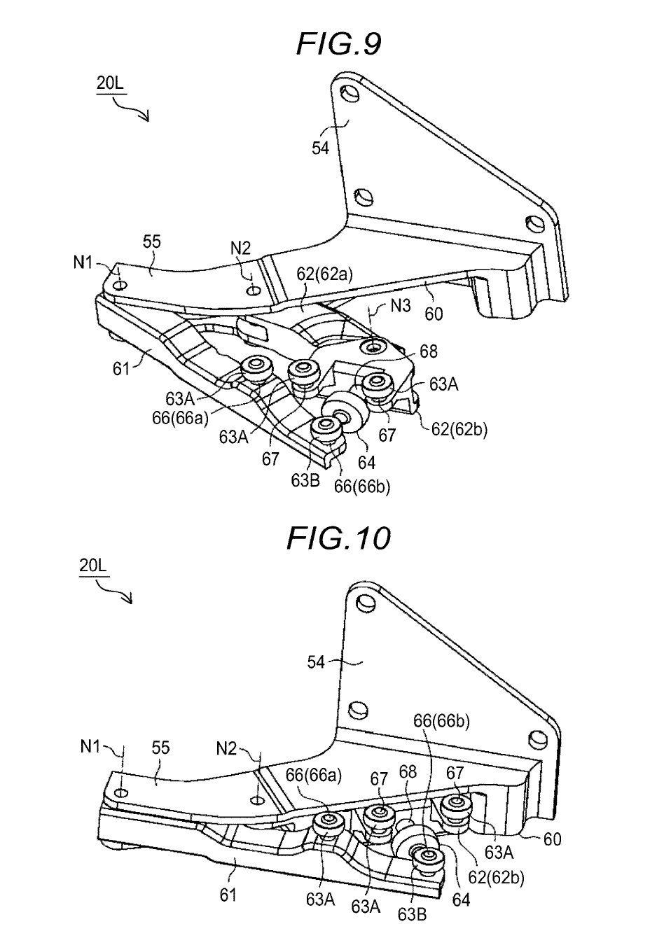

In more detail, as illustrated in FIGS. 7 to 10, the lower roller unit 20L of the present embodiment is provided with a support arm 60 that includes a fixing unit 54 to the inner surface 5s of the slide door 5, and an extension portion 55 which protrudes from the fixing unit 54 toward the vehicle body 2 side (upward and inward in the width direction of the vehicle in FIG. 7) and extends toward the front side of the vehicle (rightward in FIG. 7), that is, in the closing direction of the slide door 5. Further, the lower roller unit 20L is provided with first and second rotating arms 61 and 62 rotatably connected to the extension portion 55 of the support arm 60.

In the lower roller unit 20L of the present embodiment, a rotating shaft N1, which extends in the up and down direction, is provided at a tip end portion of the extension portion 55 of the support arm 60. Further, the first rotating arm 61 is connected to the extension portion 55 of the support arm 60 in a state in which the first rotating arm 61 is rotatable about the rotating shaft N1.

In addition, a rotating shaft N2, which extends in the up and down direction in the same way, is provided on the extension portion 55 of the support arm 60 at a position that becomes a base end side compared to the rotating shaft N1 of the first rotating arm 61. Further, the second rotating arm 62 is also connected to the extension portion 55 of the support arm 60 in a state in which the second rotating arm 62 is rotatable about the rotating shaft N2.

In addition, in the lower roller unit 20L of the present embodiment, the first rotating arm 61 is provided with a first guide roller 63A engaged with the first guide roller engagement unit 52A and a second guide roller 63B engaged with the second guide roller engagement unit 52B. Further, the second rotating arm 62 is provided with first guide rollers 63A engaged with the first guide roller engagement unit 52A and a load roller 64 configured to support the load of the slide door 5 in a state of being abutted on a sliding surface formed on the vehicle body 2 side.

As illustrated in FIG. 7, the lower rail 10L of the present embodiment is provided with a rail structure 65 fixed to the concave portion 51 (see FIG. 6) provided at the lower edge portion 3b of the door opening part 3, and the first and second guide roller engagement units 52A and 52B are formed on the rear side of the rail structure 65. Further, the first guide roller engagement unit 52A of the lower rail 10L of the present embodiment is disposed outside in the width direction of the vehicle compared to the second guide roller engagement unit 52B.

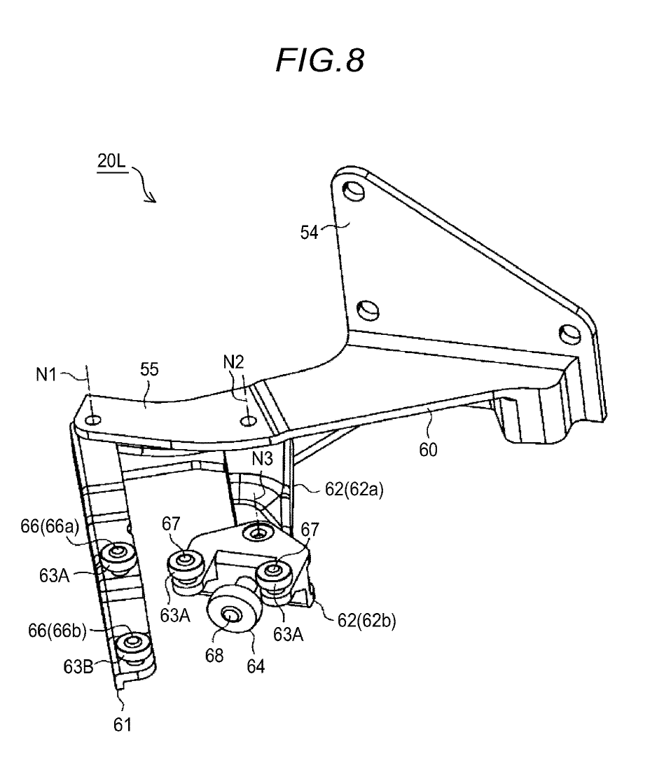

Meanwhile, as illustrated in FIGS. 8 to 10, a support shaft 66b, which extends in the up and down direction (see FIG. 6, the up and down direction in FIG. 6), is provided at a tip end portion of the first rotating arm 61 of the lower roller unit 20L of the present embodiment. In addition, the first rotating arm 61 includes a support shaft 66a which extends in the up and down direction in the same way at a position that becomes a base end side compared to the support shaft 66b. Further, the first rotating arm 61 is configured to pivotally support the first guide roller 63A by the support shaft 66a at the base end side, and pivotally support the second guide roller 63B by the support shaft 66b at the tip end side.

In addition, in the lower roller unit 20L of the present embodiment, the second rotating arm 62 is provided with a hinge 62a rotatably connected to the extension portion 55 of the support arm 60, and a roller support portion 62b connected to a tip end of the hinge 62a via a rotating shaft N3 extending in the up and down direction. In addition, the roller support portion 62b of the present embodiment is provided with two support shafts 67 that extend in the up and down direction at mutually spaced positions. In addition, the roller support portion 62b is provided with a support shaft 68 that extends in a direction (see FIG. 6, in the left and right direction in FIG. 6) that intersects the respective support shafts 67. In addition, the support shaft 68 on the roller support portion 62b of the present embodiment is provided at an intermediate position between the two support shafts 67 extending in the up and down direction and at the lower side of the two support shafts 67. Further, the lower roller unit 20L of the present embodiment is configured such that the first guide rollers 63A are pivotally supported at the tip ends of the respective support shafts 67 that extend in the up and down direction, and the load roller 64 is pivotally supported at the tip end of the support shaft 68 that extends in a direction that intersects (is substantially orthogonal to) the respective support shafts 67.

That is, as illustrated in FIG. 6, when the slide door 5 is assembled to the door opening part 3 formed on the lateral side 2a of the vehicle body 2, the tip ends of the first and second rotating arms 61 and 62 of the lower roller unit 20L of the present embodiment are inserted into the concave portion 51 formed at the lower edge portion 3b of the door opening part 3. Further, the guide rollers 63 (63A and 63B), which are provided on the first and second rotating arms 61 and 62, are configured to be connected to the lower rail 10L by being engaged with the respective guide roller engagement units 52 (52A and 52B) of the lower rail 10L disposed in the concave portion 51.

On the bottom surface 51s of the concave portion 51, a flat plate member 69, which extends along the extension direction of the first guide roller engagement unit 52A (in the direction orthogonal to the paper surface in FIG. 6), is provided at a position that becomes the lower side of the first guide roller engagement unit 52A. Further, the lower roller unit 20L of the present embodiment is configured such that the load roller 64 supported by (the roller support portion 62b of) the second rotating arm 62 is abutted on the flat plate member 69 from the upper side.

That is, in the slide door apparatus 30 of the present embodiment, the upper surface 69s of the flat plate member 69 is configured as the sliding surface XL of the load roller 64 installed at the vehicle body 2 side. In addition, in the lower roller unit 20L of the present embodiment, the pair of first guide rollers 63A provided at (the roller support portion 62b of) the second rotating arm 62 are engaged with the first guide roller engagement unit 52A at the mutually spaced positions in the extension direction of the first guide roller engagement unit 52A. Thus, the load roller 64 can be smoothly moved in the front and rear direction of the vehicle while stably supporting the load of the slide door 5 by making the direction of the load roller 64 coincident with the extension direction of the first guide roller engagement unit 52A.

Here, as illustrated in FIG. 7, in the lower rail 10L of the present embodiment, the first guide roller engagement unit 52A includes a first curved portion 71 which is curved inward in the width direction of the vehicle (upward in FIG. 7) toward the front side of the vehicle (consequently in the closing direction of the slide door 5 (toward a right side in FIG. 7)) at the front end portion 52Af side thereof, that is, at the end portion side of the first guide roller engagement unit 52A in the closing direction of the slide door 5. Further, the second guide roller engagement unit 52B is disposed inside in the width direction of the vehicle (a lower side in FIG. 7) compared to the first guide roller engagement unit 52A such that a separation distance D from the first guide roller engagement unit 52A in the width direction of the vehicle is decreased (D2<D1) at the front end portion 52Bf of the second guide roller engagement unit 52B, that is, at the end portion side of the first guide roller engagement unit 52A in the closing direction of the slide door 5.

Specifically, in the lower rail 10L of the present embodiment, the second guide roller engagement unit 52B is provided with a second curved portion 72 at the front end portion 52Bf thereof, which is curved inward in the width direction of the vehicle along the first curved portion 71 provided on the first guide roller engagement unit 52A. In addition, the second guide roller engagement unit 52B includes a third curved portion 73 which is curved outward in the width direction of the vehicle toward the front side of the vehicle to be connected to the second curved portion 72. Thus, the slide door apparatus 30 of the present embodiment is configured such that the slide door 5 supported on the lower roller unit 20L is opened and closed in the front and rear direction of the vehicle while being displaced in the width direction of the vehicle.

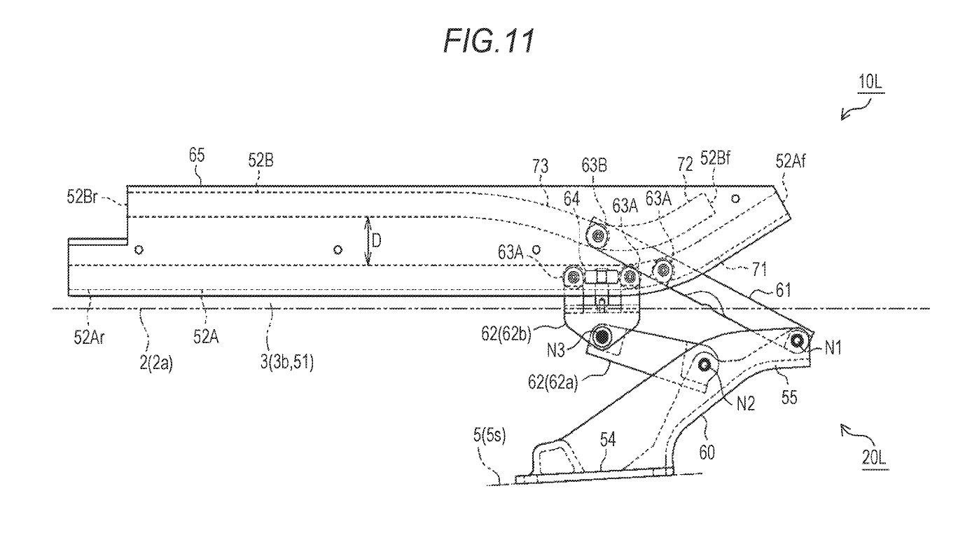

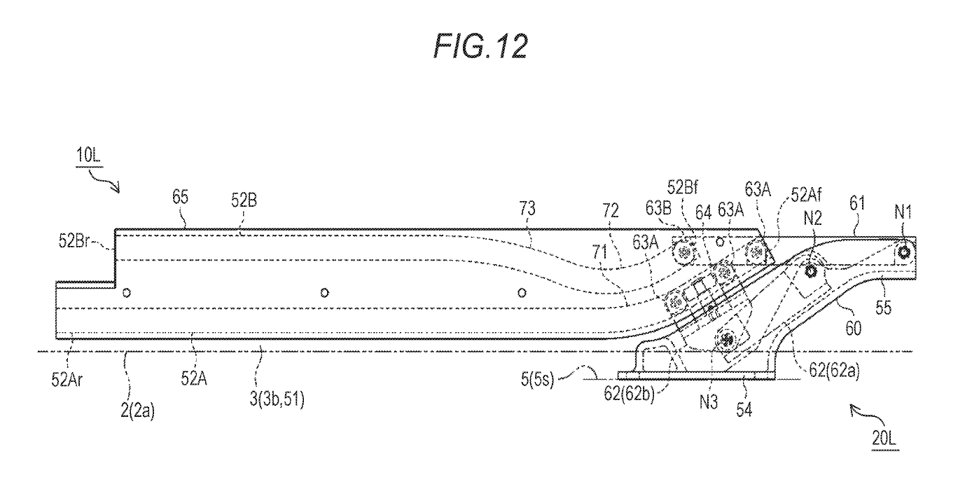

That is, as illustrated in FIGS. 7, 11 and 12, a separation distance between the first and second guide rollers 63A and 63B provided on the first rotating arm 61 is constant. For this reason, as the separation distance D between the first and second guide roller engagement units 52A and 52B is changed such that, a force for rotating the first rotating arm 61 about the rotating shaft N1 is applied to the first rotating arm 61 that is engaged with both of the first and second guide roller engagement units 52A and 52B.

The lower roller unit 20L of the present embodiment is configured such that when the slide door 5 is closed, the first and second guide rollers 63A and 63B move to the front end portions 52Af and 52Bf of the first and second guide roller engagement units 52A and 52B, and as a result, the first rotating arm 61 rotates counterclockwise about the rotating shaft N1 in the respective drawings. Thus, the slide door apparatus 30 of the present embodiment is configured such that the slide door 5 supported on the lower roller unit 20L is displaced inward in the width direction of the vehicle in a state in which the slide door 5 is drawn into the vehicle body 2.

In detail, in the lower roller unit 20L of the present embodiment, the first rotating arm 61 is configured such that as the first and second guide rollers 63A and 63B of the first rotating arm 61 move to the position where the separation distance D between the first and second guide roller engagement units 52A and 52B is decreased, the first rotating arm 61 rotates to be folded along the extension portion 55 of the support arm 60.

The second rotating arm 62 is also configured such that as the first guide rollers 63A provided on the roller support portion 62b move to the position where the first guide rollers 63A are engaged with the first curved portion 71 provided at the front end portion 52Af of the first guide roller engagement unit 52A, the second rotating arm 62 is folded along the extension portion 55 of the support arm 60.

Specifically, in this case, the hinge 62a of the second rotating arm 62 rotates counterclockwise in the respective drawings using the rotating shaft N2 provided on the extension portion 55 of the support arm 60 as a fulcrum. At this time, the roller support portion 62b of the second rotating arm 62 rotates clockwise in the respective drawings using the rotating shaft N3 provided at the tip end of the hinge 62a as a fulcrum. Further, the lower roller unit 20L of the present embodiment is configured such that when the slide door 5 is located at the completely closed position, the extension portion 55 is disposed along the first curved portion 71 provided on the first guide roller engagement unit 52A in a state in which the first and second rotating arms 61 and 62 are folded along the extension portion 55 of the support arm 60.

In the slide door apparatus 30 of the present embodiment, the lower rail 10L is configured such that the first guide roller engagement unit 52A, which is positioned outside in the width direction of the vehicle, is disposed at a position (see FIG. 6, at an upper side in FIG. 6) higher than the second guide roller engagement unit 52B positioned inside in the width direction of the vehicle. Further, the slide door apparatus 30 of the present embodiment is thus configured such that the first and second rotating arms 61 and 62 connected to the support arm 60 of the lower roller unit 20L do not interfere with each other when the first and second rotating arms 61 and 62 are folded along the extension portion 55 of the support arm 60.

As the first and second guide rollers 63A and 63B move from the front end portions 52Af and 52Bf to the rear end portions 52Ar and 52Br of the first and second guide roller engagement units 52A and 52B when the slide door 5 is opened, the first rotating arm 61 rotates clockwise in the respective drawings using the rotating shaft N1 as a fulcrum. Thus, the slide door apparatus 30 of the present embodiment is configured such that the slide door 5 supported on the lower roller unit 20L is displaced outward in the width direction of the vehicle in a state in which the slide door 5 is pushed out from the vehicle body 2 side.

In the lower rail 10L of the present embodiment, the separation distance D between the first and second guide roller engagement units 52A and 52B in the width direction of the vehicle is substantially constant (D=D2) in a section a in which the second curved portion 72 provided on the second guide roller engagement unit 52B extends along the first curved portion 71 provided on the first guide roller engagement unit 52A. That is, while the second guide roller 63B is positioned on the second curved portion 72, a rotation angle of the first rotating arm 61 is substantially constantly maintained. Thus, the slide door apparatus 30 of the present embodiment is configured such that an operation angle of the slide door 5, which moves in the front and rear direction of the vehicle while being displaced in the width direction of the vehicle when the slide door 5 is opened from the completely closed position and closed to the completely closed position, is reduced, and as a result, the slide door 5 does not interfere with a front door (not illustrated) that is located adjacent to the slide door 5 in the vicinity of the completely closed position.

According to the present embodiment as described above, the following effects can be obtained. (1) The lower rail 10L includes the first and second guide roller engagement units 52A and 52B extending in the front and rear direction of the vehicle in parallel to each other in the width direction of the vehicle, and the lower roller unit 20L includes the first rotating arm 61 rotatably connected to the slide door 5. In addition, the first rotating arm 61 includes the first guide roller 63A engaged with the first guide roller engagement unit 52A, and the second guide roller 63B engaged with the second guide roller engagement unit 52B. In addition, the first guide roller engagement unit 52A includes the first curved portion 71 curved inward in the width direction of the vehicle toward the front side of the vehicle at the front end portion 52Af positioned in the closing direction of the slide door 5. Further, since the second guide roller engagement unit 52B is disposed inside in the width direction of the vehicle compared to the first guide roller engagement unit 52A, the separation distance D from the first guide roller engagement unit 52A in the width direction of the vehicle is reduced at the front end portion 52Bf positioned in the closing direction of the slide door 5.

According to the above described configuration, a force for rotating the first rotating arm 61 engaged with both of the first and second guide roller engagement units 52A and 52B is applied to the front end portions 52Af and 52Bf of the first and second guide roller engagement units 52A and 52B positioned in the closing direction of the slide door 5. That is, when the slide door 5 is closed, the slide door 5 supported on the lower roller unit 20L is displaced inward, by the rotation of the first rotating arm 61, in the width direction of the vehicle in a state in which the slide door 5 is drawn into the vehicle body 2 side. In addition, when the slide door 5 is opened, the first rotating arm 61 rotates in a direction opposite to that in closing the slide door 5, and as a result, the slide door 5 supported on the lower roller unit 20L is displaced outward in the width direction of the vehicle in a state in which the slide door 5 is pushed out of the vehicle body 2. Thus, the slide door 5 can be greatly displaced in the width direction of the vehicle.

In addition, the outside, in the width direction of the vehicle, of the first curved portion 71 installed on the first guide roller engagement unit 52A can be used as a lower roller unit L accommodating space. Therefore, it is possible to suppress the lower rail 10L disposition space and the lower roller unit 20L accommodating space smaller while securing a displacement amount in the width direction of the vehicle which is required for the opening and closing operation of the slide door 5.

(2) The second guide roller engagement unit 52B includes the second curved portion 72 which is curved inward in the width direction of the vehicle along the first curved portion 71 provided on the first guide roller engagement unit 52A at the front end portion 52Bf thereof positioned in the closing direction of the slide door 5.

According to the above described configuration, the separation distance D between the first and second guide roller engagement units 52A and 52B in the width direction of the vehicle can be substantially constantly maintained (D=D2) in a section a in which the first curved portion 71 provided on the first guide roller engagement unit 52A and the second curved portion 72 provided on the second guide roller engagement unit 52B run in parallel with each other. As a result, while the second guide roller 63B is positioned on the second curved portion 72, the rotation angle of the first rotating arm 61 can be substantially constantly maintained. That is, it is possible to reduce an operation angle (an angle of a movement trajectory in the front and rear direction of the vehicle) of the slide door 5 which moves in the front and rear direction of the vehicle while being displaced in the width direction of the vehicle when the slide door 5 is opened from the completely closed position and closed to the completely closed position. Thus, it is possible to prevent the slide door 5 from interfering with the front door (not illustrated) which is located adjacent to the slide door 5 in the vicinity of the completely closed position.

(3) The second guide roller engagement unit 52B includes the third curved portion 73 curved outward in the width direction of the vehicle toward the front side of the vehicle in the closing direction of the slide door 5 to be connected to the second curved portion 72.

According to the above described configuration, the separation distance D between the first and second guide roller engagement units 52A and 52B can be set to be larger at the side of the rear end portions 52Ar and 52Br of the first and second guide roller engagement units 52A and 52B than at the side of the first and second curved portions 71 and 72. Thus, it is possible to greatly displace the slide door 5 supported on the lower roller unit 20L in the width direction of the vehicle when the slide door 5 is opened and closed while suppressing the lower rail 10L disposition space and the lower roller unit 20L accommodating space small.

(4) The lower roller unit 20L is provided with the support arm 60 fixed to the slide door 5. In addition, the support arm 60 is provided with the fixing unit 54 to the slide door 5, and the extension portion 55 which protrudes from the fixing unit 54 toward the vehicle body 2 and extends toward the front side of the vehicle in the closing direction of the slide door 5. Further, the first rotating arm 61 is connected to the tip end portion of the extension portion 55 such that as the first and second guide rollers 63A and 63B move to the position where the separation distance D between the first and second guide roller engagement units 52A and 52B is reduced, the first rotating arm 61 rotates to be folded along the extension portion 55 of the support arm 60. Therefore, it is possible to suppress the lower roller unit 20L accommodating space smaller.

(5) The lower roller unit 20L is configured such that the support arm 60 is disposed along the first curved portion 71 provided on the first guide roller engagement unit 52A in a state in which the first rotating arm 61 is folded. Therefore, it is possible to further suppress the lower roller unit 20L accommodating space smaller.

(6) The lower roller unit 20L is provided with the second rotating arm 62 having the load roller 64 that supports the load of the slide door 5 in a state in which the load roller 64 is abutted on the sliding surface XL formed at the vehicle body 2. Further, the second rotating arm 62 is connected to the extension portion 55 of the support arm 60 at the position that becomes the base end side compared to the first rotating arm 61 such that the second rotating arm 62 is folded together with the first rotating arm 61 along the extension portion 55 of the support arm 60.

According to the above described configuration, it is possible to smoothly move the lower roller unit 20L in the extension direction of the lower rail 10L while stably supporting the load of the slide door 5. That is, the second rotating arm 62, which supports the load roller 64, can be connected at a position closer to the fixing unit 54 to the slide door 5. Further, because the first and second rotating arms 61 and 62 are configured to be folded along the extension portion 55 of the support arm 60, it is possible to suppress the lower roller unit 20L accommodating space smaller.

(7) The first guide roller engagement unit 52A, which is positioned outside in the width direction of the vehicle, is disposed at a position higher than the second guide roller engagement unit 52B positioned inside in the width direction of the vehicle. According to the configuration, the first and second rotating arms 61 and 62 are folded along the extension portion 55 of the support arm 60, and as a result, it is possible to make the first and second rotating arms 61 and 62 not interfere with each other. As a result, it is possible to further suppress the lower roller unit 20L accommodating space smaller.

(8) The second rotating arm 62 is provided with the hinge 62a which is rotatably connected to the extension portion 55 of the support arm 60, and the roller support portion 62b which supports the load roller 64 in a state in which the roller support portion 62b is rotatably connected to the hinge 62a. Further, the pair of first guide rollers 63A, which are engaged with the first guide roller engagement unit 52A, are provided on the roller support portion 62b at the mutually spaced positions in the extension direction of the first guide roller engagement unit 52A.

According to the above described configuration, the direction of the load roller 64 can be coincident with the extension direction of the first guide roller engagement unit 52A. Thus, it is possible to more smoothly move the lower roller unit 20L in the extension direction of the lower rail 10L while stably supporting a load of the slide door 5.

The embodiment can be modified as follows.
The slide door 5 can be a power slide door having an opening and closing driving device, or can be a manual slide door.
In the embodiment, the slide door 5 is specified as a slide door 5 configured as a rear door of the vehicle 1. However, without being limited thereto, the slide door 5 can be applied to the front door of the vehicle. Further, regarding the directions of the opening and closing operations, the operation is not limited to the operation in which the slide door is closed to the front side of the vehicle (rearward opening), but the operation in which the slide door is closed to the rear side of the vehicle (forward opening) can be applied.
In the embodiment, regarding the lower rail 10L provided at the lower edge portion 3b of the door opening part 3, the configuration having the first and second guide roller engagement units 52A and 52B that extend in the front and rear direction of the vehicle in parallel with each other in the width direction of the vehicle is applied. Further, regarding the lower roller unit 20L connected to the lower rail 10L, the configuration in which the first guide roller 63A engaged with the first guide roller engagement unit 52A and the second guide roller 63B engaged with the second guide roller engagement unit 52B are provided is applied. However, without being limited thereto, and for example, the configurations can be applied to the upper rail 10U and the upper roller unit 20U provided in the upper edge portion 3a of the door opening part 3. Therefore, an interior space of the vehicle can be effectively used at a ceiling portion in the vicinity of the upper edge portion 3a of the door opening part 3. In addition, the configurations can be applied to a door side guide rail provided on the inner surface of the slide door, and a vehicle body side guide roller unit connected to the door side guide rail. Thus, it is possible to suppress the thickness of the slide door in the width direction of the vehicle, including the door side guide rail, thinner.
In the embodiment, the second guide roller engagement unit 52B is provided, at the front end portion 52Bf thereof, with the second curved portion 72 which is curved inward in the width direction of the vehicle along the first curved portion 71 provided on the first guide roller engagement unit 52A, and the third curved portion 73 which is curved outward in the width direction of the vehicle toward the front side of the vehicle to be connected to the second curved portion 72. However, without being limited thereto, the second guide roller engagement unit 52B can not have the third curved portion 73. Further, the second guide roller engagement unit 52B can not have the second curved portion 72.
In the embodiment, the first guide roller engagement unit 52A positioned outside in the width direction of the vehicle is disposed at a position higher than the second guide roller engagement unit 52B positioned inside in the width direction of the vehicle. However, the second guide roller engagement unit 52B side can be disposed at a position higher than the first guide roller engagement unit 52A. Therefore, even though the first and second guide roller engagement units 52A and 52B are disposed at different positions in the up and down direction, the first and second rotating arms 61 and 62 can be made not to interfere with each other when the first and second rotating arms 61 and 62 are folded along the extension portion 55 of the support arm 60.
In addition, the configuration of the second rotating arm 62 can be arbitrarily modified. For example, the number of first guide rollers 63A provided on the second rotating arm 62 may be one, or three or more. Further, as long as the second rotating arm 62 is folded together with the first rotating arm 61 along the extension portion 55 of the support arm 60, even a configuration in which the second rotating arm 62 does not have the first guide roller 63A is not excluded.
In addition, the second rotating arm 62 may be configured not to have a portion serving as a joint in the middle thereof in the longitudinal direction. That is, the second rotating arm 62 may be configured to directly support the load roller 64 and the first guide roller 63A, for example, at the tip end portion of the hinge 62a without having a portion such as the roller support portion 62b that is connected to the hinge 62a via the rotating shaft N3. Further, a configuration in which the guide roller unit 20 (the lower roller unit 20L) does not have the second rotating arm 62 may be adopted.
In the embodiment, the first rotating arm 61 is rotatably connected to the slide door 5 through the support arm 60 as the first rotating arm 61 is pivotally supported on the rotating shaft N1 provided on the extension portion 55 of the support arm 60 fixed to the inner surface 5s of the slide door 5. However, without being limited thereto, the shape of the support arm 60 may be arbitrarily modified. In addition, in a case in which the slide door 5 is in the completely closed position, the lower roller unit 20L accommodating space may be made smaller. Further, the first rotating arm 61 may be configured to be rotatably connected directly to the slide door 5. For example, the first rotating arm 61 may be pivotally supported on a rotating shaft provided on the inner surface 5s of the slide door 5.
In the embodiment, the lower rail 10L has a rail structure 65 fixed in the concave portion 51 provided at the lower edge portion 3b of the door opening part 3. Further, the first and second guide roller engagement units 52A and 52B are integrally formed at the rear side of the rail structure 65. However, without being limited thereto, the lower rail 10L including the first and second guide roller engagement units 52A and 52B may be formed by disposing two independently formed rail members side by side.

Next, the technical ideas, which are conceivable from the foregoing embodiments, will be described together with effects.

A slide door apparatus for a vehicle according to an aspect of this disclosure includes: a guide rail extending in a front and rear direction of the vehicle along a peripheral edge of a door opening part formed at a lateral side of a vehicle body, and a guide roller unit that supports the slide door on the lateral side of the vehicle body in a state in which the guide roller unit is connected to the guide rail. The guide rail includes first and second guide roller engagement units extending in the front and rear direction of the vehicle in parallel with each other in a width direction of the vehicle, the guide roller unit includes a first rotating arm rotatably connected to the slide door, and the first rotating arm is provided with a first guide roller engaged with the first guide roller engagement unit and a second guide roller engaged with the second guide roller engagement unit. The first guide roller engagement unit includes a first curved portion, which is curved inward in the width direction of the vehicle in a closing direction of the slide door, at an end portion in the closing direction of the slide door, and the second guide roller engagement unit is disposed further inward in the width direction of the vehicle than the first guide roller engagement unit, such that a separation distance in the width direction of the vehicle from the first guide roller engagement unit is decreased at the end portion in the closing direction of the slide door.

According to the configuration described above, a force for rotating the first rotating arm engaged with both of the first and second guide roller engagement units is applied at the end side in the closing direction of the slide door. That is, when the slide door is closed, the slide door supported on the guide roller unit is displaced inward in the width direction of the vehicle by the rotation of the first rotating arm in a state in which the slide door is drawn into the vehicle body. In addition, when the slide door is opened, the first rotating arm rotates in a direction opposite to the direction at the time of closing the slide door, and as a result, the slide door supported on the guide roller unit is displaced outward in the width direction of the vehicle in a state in which the slide door is pushed out of the vehicle body. Thus, the slide door can be greatly displaced in the width direction of the vehicle.

In addition, the outside, in the width direction of the vehicle, of the first curved portion provided on the first guide roller engagement unit can be used as a guide roller unit accommodating space. Therefore, it is possible to suppress the guide rail disposition space and the guide roller unit accommodating space smaller while securing a displacement amount in the width direction of the vehicle which is required for the opening and closing operation of the slide door.

In the slide door apparatus for a vehicle, it is preferable that the second guide roller engagement unit has a second curved portion which is curved inward in the width direction of the vehicle along the first curved portion provided on the first guide roller engagement unit, at the end portion in the closing direction of the slide door.

According to the configuration described above, the separation distance between the first and second guide roller engagement units in the width direction of the vehicle can be maintained to be substantially constant in a section in which the first curved portion provided on the first guide roller engagement unit and the second curved portion provided on the second guide roller engagement unit run in parallel with each other. As a result, while the second guide roller is positioned on the second curved portion, the rotation angle of the first rotating arm can be maintained to be substantially constant. That is, in connection with the slide door that moves in the front and rear direction of the vehicle while being displaced in the width direction of the vehicle when the slide door is opened from the completely closed position and closed to the completely closed position, it is possible to reduce the operation angle of the slide door. Thus, it is possible to prevent the slide door from interfering with a vehicle door located adjacent to the slide door in the vicinity of the completely closed position.

In the slide door apparatus for a vehicle, it is preferable that the second guide roller engagement unit includes a third curved portion, which is curved outward in the width direction of the vehicle toward the closing direction of the slide door to be connected to the second curved portion.

According to the configuration described above, the separation distance between the first and second guide roller engagement units can be set to be greater at a portion in the opening direction of the slide door than at the first and second curved portions. Thus, it is possible to greatly displace the slide door supported on the guide roller unit in the width direction of the vehicle when the slide door is opened and closed while suppressing the guide rail disposition space and the guide roller unit accommodating space smaller.

In the slide door apparatus for a vehicle, it is preferable that the guide roller unit includes a support arm fixed to the slide door, and the support arm includes an extension portion that protrudes from a fixing unit to the slide door toward the vehicle body side and extends in the closing direction of the slide door, and the first rotating arm is connected to the corresponding extension portion such that as the first and second guide rollers move to a position where the separation distance between the first and second guide roller engagement units is decreased, the first rotating arm rotates to be folded along the extension portion of the support arm.

According to the configuration described above, it is possible to suppress the guide roller unit accommodating space smaller.

In the slide door apparatus for a vehicle, it is preferable that the guide roller unit is configured such that the support arm is disposed along the first curved portion provided on the first guide roller engagement unit in a state in which the first rotating arm is folded.

According to the configuration described above, it is possible to further suppress the guide roller unit accommodating space smaller.

In the slide door apparatus for a vehicle, it is preferable that the guide roller unit includes a second rotating arm that is provided with a load roller that supports a load of the slide door in a state of being abutted on a sliding surface formed on the vehicle body side, and the second rotating arm is connected to the extension portion of the support arm at a position that becomes a base end side compared to the first rotating arm such that the second rotating arm is folded together with the first rotating arm along the extension portion of the support arm.

According to the configuration described above, it is possible to smoothly move the guide roller unit in the extension direction of the guide rail while stably supporting a load of the slide door. That is, the second rotating arm, which supports the load roller, can be connected at a position closer to the fixing unit to the slide door. Further, since the first and second rotating arms are configured to be folded along the extension portion of the support arm, it is possible to suppress the guide roller unit accommodating space smaller.

In the slide door apparatus for a vehicle, it is preferable that the second rotating arm includes a hinge that is rotatably connected to the extension portion of the support arm, and a roller support portion that supports the load roller in a state in which the roller support portion is rotatably connected to the hinge, and the first guide rollers engaged with the first guide roller engagement unit are provided on the roller support portion at mutually spaced positions in an extension direction of the first guide roller engagement unit.

According to the configuration described above, the direction of the load roller can be coincident with the extension direction of the first guide roller engagement unit. Thus, it is possible to more smoothly move the guide roller unit in the extension direction of the guide rail while stably supporting a load of the slide door.

It is preferable that the slide door apparatus for a vehicle includes a pair of the first guide rollers that are engaged with the first guide roller engagement unit.

In the slide door apparatus for a vehicle, it is preferable that the guide rail is provided at a lower edge portion of the door opening part.

According to the configuration described above, it is possible to inhibit the guide rail disposition space and the guide roller unit accommodating space from occupying the interior space of the vehicle in the vicinity of the lower edge portion of the door opening part. Thus, it is possible to implement a low floor type vehicle such that the interior space of the vehicle can be used more effectively.

In the slide door apparatus for a vehicle, it is preferable that the guide rail is provided at an upper edge portion of the door opening part.

In the slide door apparatus for a vehicle, it is preferable that the first and second guide roller engagement units of the guide rail are disposed at different positions in the up and down direction.

According to the configuration described above, it is possible to make the first and second rotating arms from not interfere with each other when the first and second rotating arms are folded along the extension portion of the support arm. As a result, it is possible to further suppress the guide roller unit accommodating space smaller.

In the slide door apparatus for a vehicle, it is preferable that the guide rail includes a rail structure integrally formed by connecting the first and second guide roller engagement units to each other.

It is preferable that the slide door apparatus for a vehicle further includes a guide rail extending in a front and rear direction of the vehicle, and a guide roller unit connected to the guide rail, the guide rail includes first and second guide roller engagement units that extend in the front and rear direction of the vehicle in parallel with each other in a width direction of the vehicle, and are installed at one lateral side of a vehicle body formed with a door opening part and at one side of a slide door for opening and closing the door opening part, the guide roller unit has a first rotating arm rotatably connected to the lateral side of the vehicle body and to the other side of the slide door, and the first rotating arm is provided with a first guide roller engaged with the first guide roller engagement unit and a second guide roller engaged with the second guide roller engagement unit, and the first guide roller engagement unit has a first curved portion curved in the width direction of the vehicle at one end of the extension direction, and the second guide roller engagement unit is disposed at a position in the width direction of the vehicle which is more spaced apart from a rotation axis of the first rotating arm than the first guide roller engagement unit such that a separation distance from the first guide roller engagement unit is decreased at one end in the extension direction parallel to the first curved portion provided on the first guide roller engagement unit.

According to the aspect of this disclosure, it is possible to suppress the guide rail disposition space and the guide roller unit accommodating space to smaller sizes.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A slide door apparatus for a vehicle comprising:
a guide rail extending in a front and rear direction of the vehicle along a peripheral edge of a door opening part formed on a lateral side of a vehicle body; and
a guide roller unit configured to support the slide door on the lateral side of the vehicle body in a state in which the guide roller unit is connected to the guide rail,
wherein the guide rail includes first and second guide roller engagement units extending in the front and rear direction of the vehicle in parallel with each other in a width direction of the vehicle, the guide roller unit includes a first rotating arm rotatably connected to the slide door, and the first rotating arm is provided with a first guide roller engaged with the first guide roller engagement unit and a second guide roller engaged with the second guide roller engagement unit, and
wherein the first guide roller engagement unit includes a first curved portion, which is curved inward in the width direction of the vehicle toward a closing direction of the slide door, at an end portion side in the closing direction of the slide door, and the second guide roller engagement unit is disposed inside in the width direction of the vehicle compared to the first guide roller engagement unit such that a separation distance of the second guide roller engagement unit from the first guide roller engagement unit in the width direction of the vehicle is decreased at the end portion side in the closing direction of the slide door.

2. The slide door apparatus according to claim 1, wherein the second guide roller engagement unit includes a second curved portion, which is curved inward in the width direction of the vehicle along the first curved portion provided on the first guide roller engagement unit, at the end portion side in the closing direction of the slide door.

3. The slide door apparatus according to claim 2, wherein the second guide roller engagement unit has a third curved portion, which is curved outward in the width direction of the vehicle toward the closing direction of the slide door to be connected to the second curved portion.

4. The slide door apparatus according to claim 1, wherein the guide roller unit includes a support arm fixed to the slide door, and the support arm includes an extension portion that protrudes from a fixing unit to the slide door toward the vehicle body side and extends in the closing direction of the slide door, and
wherein the first rotating arm is connected to the extension portion such that as the first and second guide rollers move to a position where the separation distance between the first and second guide roller engagement units is decreased, the first rotating arm rotates to be folded along the extension portion of the support arm.

5. The slide door apparatus according to claim 4, wherein the guide roller unit is configured such that the support arm is disposed along the first curved portion provided on the first guide roller engagement unit in a state in which the first rotating arm is folded.

6. The slide door apparatus according to claim 4, wherein the guide roller unit includes a second rotating arm that is provided with a load roller that supports a load of the slide door in a state of being abutted on a sliding surface formed on the vehicle body side, and the second rotating arm is connected to the extension portion of the support arm at a position that becomes a base end side compared to the first rotating arm such that the second rotating arm is folded together with the first rotating arm along the extension portion of the support arm.

7. The slide door apparatus according to claim 6, wherein the second rotating arm includes a hinge that is rotatably connected to the extension portion of the support arm, and a roller support portion that supports the load roller in a state in which the roller support portion is rotatably connected to the hinge, and
wherein the first guide rollers engaged with the first guide roller engagement unit are provided on the roller support portion at mutually spaced positions in an extension direction of the first guide roller engagement unit.

8. The slide door apparatus according to claim 7, comprising a pair of the first guide rollers that are engaged with the first guide roller engagement unit.

9. The slide door apparatus according to claim 1, wherein the guide rail is provided at a lower edge portion of the door opening part.

10. The slide door apparatus according to claim 1, wherein the guide rail is provided at an upper edge portion of the door opening part.

11. The slide door apparatus according to claim 1, wherein, in the guide rail, the first and second guide roller engagement units of the guide rail are disposed at different positions in an up and down direction.

12. The slide door apparatus according to claim 1, wherein the guide rail includes a rail structure integrally formed by connecting the first and second guide roller engagement units to each other.
